(19) United States
(12) Patent Application Publication
(10) Pub. No.: US 2025/0089110 A1
(43) Pub. Date: Mar. 13, 2025

(54) WIRELESS LOCAL AREA NETWORK COMMUNICATION SYSTEM FOR FERRIS WHEEL

(71) Applicant: Yi LU, Tianjin (CN)

(72) Inventor: Yi LU, Tianjin (CN)

(21) Appl. No.: 18/961,280

(22) Filed: Nov. 26, 2024

Related U.S. Application Data
(63) Continuation of application No. PCT/CN2023/116863, filed on Sep. 5, 2023.

(30) Foreign Application Priority Data
Oct. 25, 2022 (CN) 202222810422.8

(51) Int. Cl. H04W 76/10; H04B 1/38; H04W 84/12

(52) U.S. Cl. CPC H04W 76/10; H04B 1/38; H04W 84/12

(57) ABSTRACT

A wireless local area network communication system for a Ferris wheel is formed by connecting a wireless node device mounted on each gondola and a wireless center device mounted on a Ferris wheel supporting frame, and each wireless node device is connected to a downstream device in the gondola; and the center device is connected to an upstream device. By mounting antennas of the wireless center device at positions near a center shaft of the Ferris wheel supporting frame, the invention effectively ensures that all the gondolas will not affect a data communication effect during operation due to a change of a communication distance; and by mounting dual antennas of the wireless node device at external diagonal positions of the gondola, at least one antenna communicates with the wireless center device when the gondola operates at any position.

### CROSS-REFERENCE TO RELATED APPLICATIONS

This application is a continuation of International Patent Application No. PCT/CN2023/116863 with a filing date of Sep. 5, 2023, designating the United States, now pending. The content of the aforementioned applications, including any intervening amendments thereto, are incorporated herein by reference

### TECHNICAL FIELD

The present invention belongs to the technical field of communication, relates to a wireless local area network, and is particularly a wireless local area network communication system for a Ferris wheel.

### BACKGROUND OF THE PRESENT INVENTION

Ferris wheel is a large-scale wheel-shaped mechanical construction facility, on which a gondola for passengers to ride is hung at a wheel edge, and during the slow rotation of the Ferris wheel, the passengers may overlook the surrounding scenery from a height. In order to improve the safety and sense of science and technology (participation, entertainment and functionality) of the Ferris wheel, it is necessary to mount devices with large screen projection, digital broadcasting, an intercom, monitoring, environmental awareness, smoke alarm and other functions inside the gondola. All the above devices generally need digital network support, and the most economical, stable and efficient digital network scheme is to compose the gondola and a ground machine room into a local area network.

One solution is to adopt a wired local area network scheme. Due to a special mechanical structure of the Ferris wheel, in the wired local area network scheme, a slip ring and other mechanical devices must be mounted on a rotating shaft of the gondola and a main shaft of the Ferris wheel to stably transmit a wired signal to the ground machine room, and the scheme of adding the mechanical devices increases a design difficulty of the Ferris wheel, and also increases later operation and maintenance costs at the same time. For the Ferris wheel that is already in operation, it is difficult to change the design and implementation because of safety problem. Another solution is to adopt a wireless local area network scheme. At present, the wireless local area network scheme mainly comprises the following two ways.

1. A node device is mounted in each gondola, a device antenna is mounted below the gondola, and a direction of the antenna is oriented to the ground; and a center device is mounted on the ground, which uses a directional antenna oriented to the sky. The main problem of this scheme is that, when the gondola operates to a top end position, the gondola is far away from the center device. Meanwhile, due to a complex structure of the Ferris wheel, there were the strongest shielding and interference to a radio signal, which easily leads to the instability of wireless signal, thus affecting stable data transmission.

2. The patent document 201621452037.9 discloses a communication structure of a Ferris wheel, and the communication structure needs to be subjected to wired signal and wireless signal conversion twice. Because radio channels are limited resources, this scheme cannot effectively use all radio channels, resulting in a waste of resources. Moreover, this scheme has poor compatibility and expansibility to wireless local area network standards, so that it is difficult to realize new technologies of the wireless local area network standards, such as an MIMO technology (multiple-input-multiple-output technology).

### SUMMARY OF THE PRESENT INVENTION

The present invention aims to overcome the defects in the prior art, and provide a wireless local area network communication system for a Ferris wheel, with reasonable design, strong stability, and convenient mounting and maintenance.

The present invention solves the existing technical problems by adopting the following technical solutions.

A wireless local area network communication system for a Ferris wheel is formed by connecting a wireless node device mounted on each gondola and a wireless center device mounted on a Ferris wheel supporting frame, and each wireless node device is connected to a downstream device in the gondola; and the center device is connected to an upstream device.

Further, the wireless node device comprises at least one radio transceiver module, the radio transceiver module is provided with at least two antennas, and the antennas are connected to the radio transceiver module through feeders.

Further, the wireless node device comprises at least two radio transceiver modules capable of working independently, each radio transceiver module is provided with at least one antenna, and the antenna is connected to the radio transceiver module through a feeder.

Further, the antenna of the wireless node device is an omni-directional antenna, two antennas are respectively mounted at external diagonal positions of the gondola, and length directions of the antennas are consistent with a direction of a center shaft of the Ferris wheel.

Further, one or more wireless center devices are provided, the wireless center devices are mounted on a Ferris wheel supporting frame, antennas of the wireless center devices are mounted around a center shaft of the Ferris wheel supporting frame, and the wireless center devices are connected to the antennas through feeders.

Further, the antenna of the wireless center device is an omni-directional antenna or a directional antenna; when the omni-directional antenna is used, length directions of the antennas are consistent with a direction of a center shaft of the Ferris wheel; and when the directional antenna is used, the antennas are mounted by taking the center shaft of the Ferris wheel as a center of circle, sequentially arranging to form circular distribution, and allowing back surfaces of the antennas to be all oriented to the center of circle.

Further, the wireless node device is connected to the downstream device in the gondola in a wired or wireless way, and the wireless center device is connected to the upstream device on the ground in a wired or wireless way.

The present invention has the advantages and positive effects as follows.

1. By mounting the antennas of the wireless center device at positions near the center shaft of the Ferris wheel supporting frame, the present invention can effectively ensure that all the gondolas will not affect a data communication effect during operation due to a change of a communication distance; and meanwhile, by increasing numbers of the wireless center devices and the antennas and reasonably distributing a layout of the antennas of the wireless center devices, radio channel resources can be fully utilized to obtain a maximum communication bandwidth. Meanwhile, by mounting dual antennas of the wireless node device at external diagonal positions of the gondola, it is ensured that at least one antenna communicates with the wireless center device when the gondola operates at any position; and by increasing numbers of the transceiver modules and the antennas of the wireless node device, new technologies of subsequent wireless local area network standards, such as MIMO, can be expanded.

2. Without changing the structure of the Ferris wheel, the present invention uses a mature wireless local area network device to realize reliable networking communication of the wireless local area network, so that wireless local area network devices and antennas with different performance parameters may be selected according to the use requirements of different Ferris wheel structures, rim diameters, rotating speeds, bandwidth requirements and surrounding environment requirements, thus obtaining the optimal communication effect.

### DESCRIPTION OF THE DRAWINGS

FIG. 1 is a schematic diagram of a topological structure of a single antenna of a single center device according to the present invention;

FIG. 2 is a schematic diagram of a topological structure of a plurality of antennas of the single center device according to the present invention;

FIG. 3 is a schematic diagram of a topological structure of single antennas of a plurality of center devices according to the present invention;

FIG. 4 is a schematic diagram of a topological structure of a plurality of antennas of the plurality of center devices according to the present invention;

FIG. 5 is a schematic diagram of a mixed topological structure of the single or plurality of antennas of the plurality of center devices according to the present invention;

FIG. 6 is a schematic diagram of a mounting position of an antenna on a square gondola according to the present invention;

FIG. 7 is a schematic diagram of a mounting position of an antenna on a circular gondola according to the present invention;

FIG. 8 is a schematic diagram of omni-directional antenna signal coverage of a center device according to the present invention;

FIG. 9 is a schematic diagram of directional antenna signal coverage of the center device according to the present invention; and

FIG. 10 is a schematic diagram of signal superposition of the gondola according to the present invention.

### DETAILED DESCRIPTION OF PREFERRED EMBODIMENTS

Embodiments of the present invention are further described in detail hereinafter with reference to the drawings.

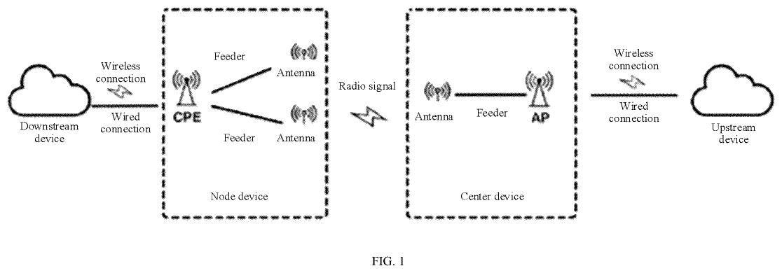

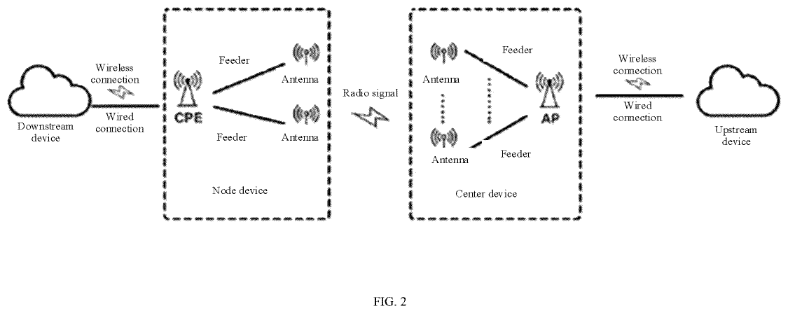

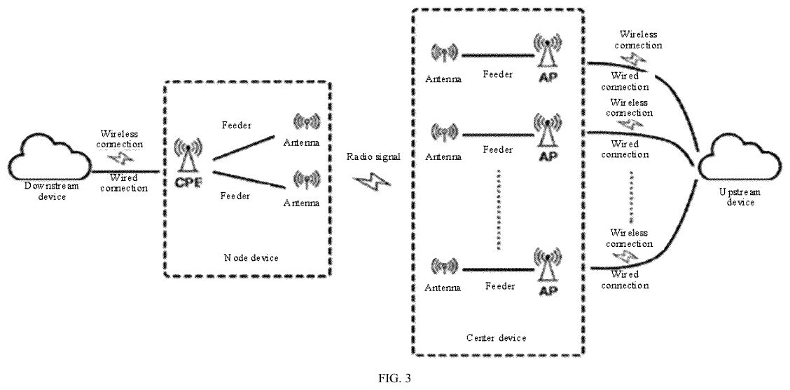

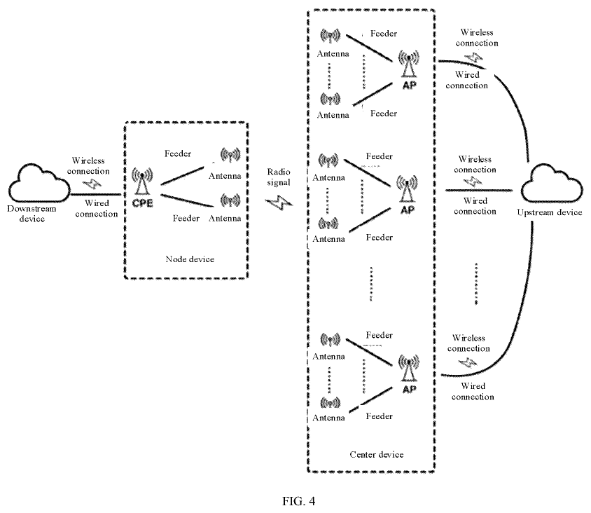

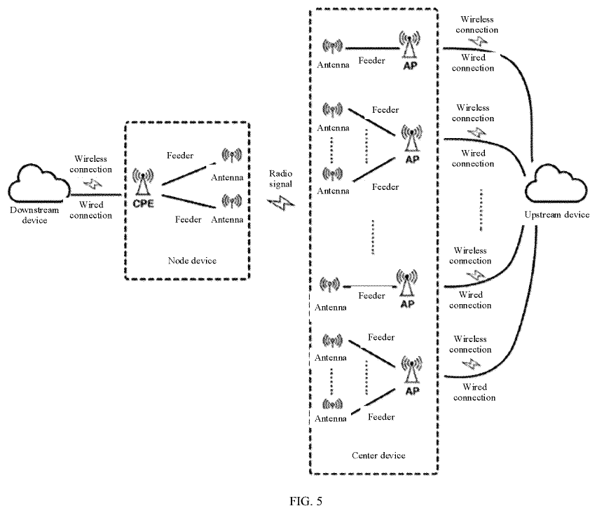

A wireless local area network communication system for a Ferris wheel, as shown in FIG. 1, FIG. 2, FIG. 3, FIG. 4 and FIG. 5, comprises a wireless node device mounted on each gondola and a wireless center device mounted on a Ferris wheel supporting frame, and various wireless node devices and the wireless center device form a wireless local area network through wireless communication. Each wireless node device is connected to a downstream device (such as large-screen projection, digital broadcasting, an intercom, a monitoring device, an environment awareness sensor and a smoke alarm) in the gondola in a wired way or a wireless way, and the wireless center device is connected to an upstream device (such as a local area network switch and a gateway router) in a wired way or a wireless way for communication.

In this wireless local area network communication system, the wireless node device adopts a wireless CPE device (Customer premises equipment), and the wireless center device adopts a wireless AP device (wireless Access Point).

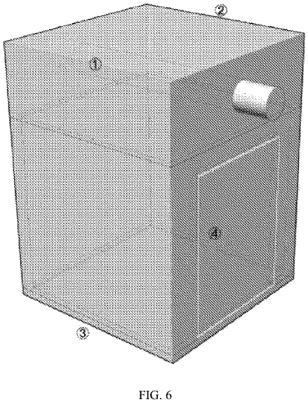

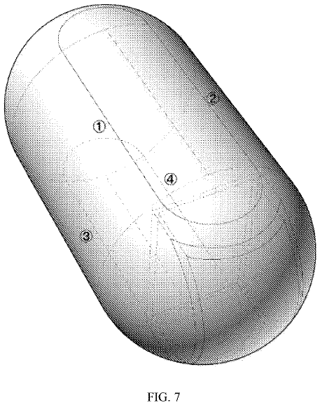

There are two kinds of wireless node devices, wherein one wireless node device comprises at least one radio transceiver module and is provided with at least two antennas at the same time; and the other wireless node device comprises at least two radio transceiver modules capable of working independently, and each module is provided with at least one antenna. The antenna of the wireless node device adopts an omni-directional antenna, and the antenna is connected to the wireless node device through a feeder. No matter what kind of wireless node device above is used, two antennas of the wireless node device are respectively mounted at external diagonal positions of the gondola, such as positions \textcircled{1} and \textcircled{4} or positions \textcircled{2} and \textcircled{3} outside the gondola as shown in FIG. 6 and FIG. 7, and length directions of the antennas are consistent with a direction of a center shaft of the Ferris wheel.

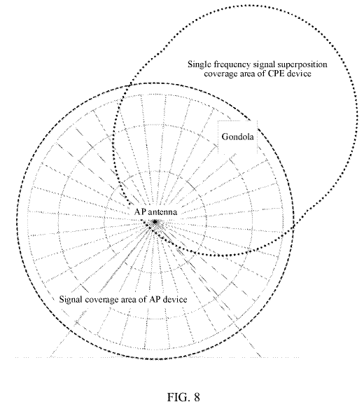

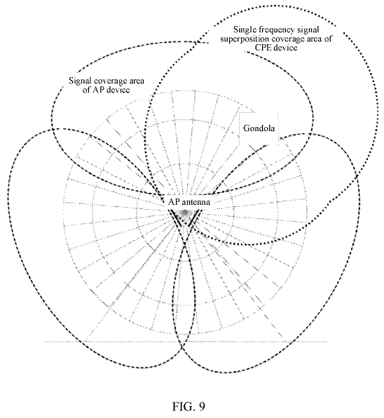

One or more wireless center devices are provided, the wireless center devices are mounted on a Ferris wheel supporting frame, antennas of the wireless center devices are mounted around a center shaft of the Ferris wheel supporting frame, and the wireless center devices are connected to the antennas through feeders. The antenna of the wireless center device is an omni-directional antenna or a directional antenna; when the omni-directional antenna is used, length directions of the antennas are consistent with a direction of a center shaft of the Ferris wheel, and antenna signal distribution is as shown in FIG. 8; and when the directional antenna is used, the antennas are mounted by taking the center shaft of the Ferris wheel as a center of circle, sequentially arranging to form circular distribution, and allowing back surfaces of the antennas to be all oriented to the center of circle, and antenna signal distribution is as shown in FIG. 9.

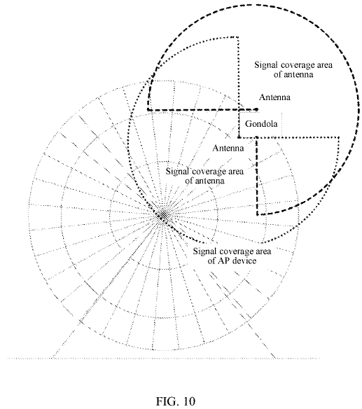

According to the mounting modes of the antenna of the wireless node device and the antenna of the wireless center device, signal superposition of the gondola is as shown in FIG. 10. It can be seen that two antennas on the gondola are completely within a wireless signal range of the wireless center device, thus realizing a reliable communication function between the wireless node device of the gondola and the wireless center device.

### Embodiment 1

This embodiment is a wireless local area network communication system for a Ferris wheel, with a topological structure of a single center device. In this embodiment, wireless communication adopts an IEEE802.11g standard as an implementation standard. A wireless node device and a wireless center device are both a TP-link brand TL-BS210 device, and provided with a rod antenna with a gain of 5 dBi, and the devices and the antennas are connected through RG142 feeders. A specific mounting mode is as follows.

Each gondola of the Ferris wheel is provided with one TL-BS210 device, and in order to make the device be a CPE device, a working mode thereof needs to be configured as a Client mode. One antenna interface of the CPE device is connected to two omni-directional antennas through a power divider, or two antenna interfaces of the CPE device are respectively connected to one omni-directional antenna. The antennas are mounted at external diagonal positions of the gondola (such as positions \textcircled{1} and \textcircled{4} or positions \textcircled{2} and \textcircled{3} outside the gondola as shown in FIG. 6 and FIG. 7), and length directions of the antennas are consistent with a direction of a center shaft of the Ferris wheel. A downstream wired/wireless network interface of the CPE device is connected to a downstream device that needs to provide services, such as monitoring and environmental awareness devices.

A Ferris wheel supporting frame is provided with one TL-BS210 device, and in order to make the device be an AP device, a working mode thereof needs to be configured as an AP mode. At least one antenna interface of the wireless AP device is connected to one omni-directional antenna, and if mounting conditions permit, two antenna interfaces are respectively connected to one omni-directional antenna at the same time. The antennas are mounted at positions near a center shaft of the Ferris wheel supporting frame, and length directions of the antennas are consistent with a direction of a center shaft of the Ferris wheel, as shown in FIG. 8. Wired/wireless network interfaces of the wireless AP device are connected to an upstream network device as required, such as a local area network switch and a gateway router.

In this embodiment, mounting positions of all TL-BS210 devices should be as close as possible to the antennas, so as to reduce use lengths of the feeders, thus reducing signal attenuation.

### Embodiment 2

This embodiment is a wireless local area network communication system for a Ferris wheel, with a topological structure of a plurality of center devices. In this embodiment, wireless communication adopts an IEEE802.11ax standard as an implementation standard. A wireless node device and a wireless center device are both a TP-link brand TL-NXAP3000 device, and provided with a rod or plate antenna with a gain of 5 dBi, and the devices and the antennas are connected through RG142 feeders. A specific mounting mode is as follows.

Each gondola of the Ferris wheel is provided with one TL-NXAP3000 device, and in order to make the device be a CPE device, a working mode thereof is configured as a Client mode. The CPE device has a total of two antenna interfaces, which are interfaces with frequencies of 2.4 Ghz and 5 Ghz respectively. Each antenna interface is connected to two omni-directional antennas through a power divider, and the antennas are mounted at external diagonal positions of the gondola, which means that 5 Ghz antennas are mounted at positions 1 and 4 in FIG. 6 or FIGS. 7, and 2.4 Ghz antennas are mounted at positions 2 and 3 in FIG. 6 or FIG. 7. Length directions of the antennas are consistent with a direction of a center shaft of the Ferris wheel. A downstream wired/wireless network interface of the CPE device is connected to a device that needs to provide services, such as monitoring and environmental awareness devices.

A Ferris wheel supporting frame is provided with three TL-NXAP3000devices at proper positions, and in order to make the devices be wireless AP devices, a working mode thereof is configured as an AP mode. Two antenna interfaces of each AP device are connected to one dual-frequency (2.4 G/5 G) directional antenna, and a horizontal lobe width of the antenna is required to be 130 degrees. The antennas are mounted at positions near a center shaft of the Ferris wheel supporting frame, and a plurality of antennas are mounted back to back in turn by taking a direction of a center shaft of the Ferris wheel as an axis, as shown in FIG. 9. During mounting, it is ensured that each antenna covers a part of the Ferris wheel, and meanwhile, it is ensured that a total coverage area can completely cover all gondolas of the Ferris wheel, and there should be an overlapping coverage area between adjacent antennas. A size of the overlapping coverage area is calculated according to parameters such as a diameter and a rotating speed of the Ferris wheel. All wired/wireless network interfaces of the AP device are connected to an upstream network device as required, such as a local area network switch and a gateway router.

A multi-antenna design of the wireless center device may ensure the signal coverage of at least one AP antenna in an operation area of the gondola, as shown in FIG. 9. Meanwhile, a dual-antenna design on the gondola may ensure that at least one antenna may communicate with the antenna of the wireless center device no matter where the gondola operates, as shown in FIG. 10. Because signals of the plurality of antennas have the overlapping coverage area, the gondola may operate between different coverage areas, so as to finally realize continuous communication between wireless local area network devices.

It should be emphasized that the embodiments described in the present invention are illustrative, and are not restrictive, so that the present invention comprises, but is not limited to, the embodiments described in the detailed description, and all other embodiments obtained by those skilled in the art according to the technical solutions of the present invention also belong to the scope of protection of the present invention.

We claim:

1. A wireless local area network communication system for a Ferris wheel, wherein: the wireless local area network communication system is formed by connecting a wireless node device mounted on each gondola and a wireless center device mounted on a Ferris wheel supporting frame, and each wireless node device is connected to a downstream device in the gondola; and the center device is connected to an upstream device.

2. The wireless local area network communication system for the Ferris wheel according to claim 1, wherein the wireless node device comprises at least one radio transceiver module, the radio transceiver module is provided with at least two antennas, and the antennas are connected to the radio transceiver module through feeders.

3. The wireless local area network communication system for the Ferris wheel according to claim 1, wherein the wireless node device comprises at least two radio transceiver modules capable of working independently, each radio transceiver module is provided with at least one antenna, and the antenna is connected to the radio transceiver module through a feeder.

4. The wireless local area network communication system for the Ferris wheel according to claim 2, wherein the antenna of the wireless node device is an omni-directional antenna, two antennas are respectively mounted at external diagonal positions of the gondola, and length directions of the antennas are consistent with a direction of a center shaft of the Ferris wheel.

5. The wireless local area network communication system for the Ferris wheel according to claim 1, wherein one or more wireless center devices are provided, the wireless center devices are mounted on a Ferris wheel supporting frame, antennas of the wireless center devices are mounted around a center shaft of the Ferris wheel supporting frame, and the wireless center devices are connected to the antennas through feeders.

6. The wireless local area network communication system for the Ferris wheel according to claim 5, wherein the antenna of the wireless center device is an omni-directional antenna or a directional antenna; when the omni-directional antenna is used, length directions of the antennas are consistent with a direction of a center shaft of the Ferris wheel; and when the directional antenna is used, the antennas are mounted by taking the center shaft of the Ferris wheel as a center of circle, sequentially arranging to form circular distribution, and allowing back surfaces of the antennas to be all oriented to the center of circle.

7. The wireless local area network communication system for the Ferris wheel according to claim 1, wherein the wireless node device is connected to the downstream device in the gondola in a wired or wireless way, and the wireless center device is connected to the upstream device on the ground in a wired or wireless way.

8. The wireless local area network communication system for the Ferris wheel according to claim 3, wherein the antenna of the wireless node device is an omni-directional antenna, two antennas are respectively mounted at external diagonal positions of the gondola, and length directions of the antennas are consistent with a direction of a center shaft of the Ferris wheel.
